(19) United States
(12) Patent Application Publication
(10) Pub. No.: US 2026/0204578 A1
(43) Pub. Date: Jul. 16, 2026

(54) HIGH PERFORMANCE BATTERY BINDER

(71) Applicants: SYENSQO SPECIALTY POLYMERS ITALY S.p.A., Bollate (Milano) (IT); POLITECNICO DI TORINO, Torino (IT)

(72) Inventors: Julio A. Abusleme, Saronno (VA) (IT); Francesco Liberale, Pavia (PV) (IT); Riccardo Rino Pieri, Milano (MI) (IT); Maurizio Biso, Milano (MI) (IT); Giulia Bernagozzi, Alessandria (AL) (IT); Alberto Frache, Alessandria (AL) (IT); Daniele Battegazzore, Alessandria (AL) (IT)

(73) Assignees: SYENSQO SPECIALTY POLYMERS ITALY S.p.A., Bollate (Milano) (IT); POLITECNICO DI TORINO, Torino (IT)

(21) Appl. No.: 19/136,795

(22) PCT Filed: Nov. 13, 2023
(86) PCT No.: PCT/EP2023/081563

§ 371 Date: Jun. 6, 2025

(30) Foreign Application Priority Data
Dec. 7, 2022 (EP) 22211974.5

(51) Int. Cl. H01M 4/62; C08F 8/42; C09D 5/24; C09D 127/22; H01G 11/30; H01M 4/04; H01M 4/131; H01M 4/1391

(52) U.S. Cl. CPC H01M 4/623; C08F 8/42; C09D 5/24; C09D 127/22; H01G 11/30; H01M 4/0404; H01M 4/131; H01M 4/1391; C08F 2810/50

(57) ABSTRACT

Fluorinated copolymers comprising recurring units bearing silane groups, and to their use as binder for electrodes in Li-ion batteries. The copolymers may include, in the backbone, recurring units bearing at least one silane group [unit (CS)] of formula —SiYₘ, wherein m is an integer from 1 to 3 and each occurrence of Y is a C₁-C₁₀ hydrolyzable group; optionally, recurring units derived from at least one fluorinated monomer [monomer (FM)] different from VDF; and optionally, recurring units derived from at least one monomer (FPM) comprising at least one functional group selected from the group consisting of: hydroxyl group, amine, carboxylic acid group, thiol group and anhydride.

### CROSS REFERENCE TO PREVIOUS APPLICATIONS

This application claims priority to European application No. 22211974.5 filed on 7 Dec. 2022, the whole content of this application being incorporated herein by reference for all purposes.

### TECHNICAL FIELD

The present invention pertains to fluorinated copolymers comprising recurring units bearing silane groups, and to their use as binder for electrodes in Li-ion batteries.

### BACKGROUND ART

Fluoropolymers are known in the art to be suitable as binders for the manufacture of electrodes for use in electrochemical devices such as secondary batteries.

Polyvinylidene fluoride (PVDF), in particular, is widely used for this purpose.

From the viewpoint of improving the safety and performance of the non-aqueous electrolyte secondary battery, the binder is required to have high adhesiveness to the active material contained in the electrode mixture and to the current collector. However, PVDF adhesiveness is not sufficient.

Various methods for improving the adhesiveness of PVDF have been proposed.

Vinylidene fluoride (VDF) copolymers comprising recurring units derived from hydrophilic (meth)acrylic monomers (e.g. acrylic acid) are well known in the art to have good mechanical properties, chemical inertness and suitable adhesion towards metals.

JP2022029314A discloses an electrode mixture for a positive electrode containing a high nickel-based positive electrode active material, a vinylidene fluoride copolymer and a silane coupling agent.

In the technical field of batteries, notably of lithium batteries, the problem of providing alternative electrode binders characterized by very good adhesion, is still felt.

### SUMMARY OF INVENTION

It is thus an object of the present invention a binder composition [binder (B)] for use in the preparation of electrodes for electrochemical devices, characterized by comprising at least one VDF-based polymer [polymer (F)] that comprises in the backbone:
recurring units bearing at least one silane group [unit (CS)] of formula —SiYₘ,
   wherein m is an integer from 1 to 3 and each occurrence of Y is a C₁-C₁₀ hydrolyzable group, preferably a C₂-C₅ hydrolyzable group; and
optionally, recurring units derived from at least one fluorinated monomer [monomer (FM)], different from VDF; and
optionally, recurring units derived from at least one monomer (FPM) comprising at least one functional group [group (FX)] selected from the group consisting of: hydroxyl group, amine, carboxylic acid group, thiol group and anhydride.

In another aspect, the present invention provides an electrode-forming composition [composition (C1)] for use in the preparation of electrodes for electrochemical devices, characterized by comprising:
a) at least one electrode active material (AM);
b) at least one binder (B), wherein binder (B) comprises at least one polymer (F) as above defined; and
c) at least one organic solvent (OS).

In a further aspect, the present invention provides an electrode-forming composition [composition (C2)] for use in the preparation of electrodes for electrochemical devices, characterized by comprising:
a) at least one electrode active material (AM);
b) at least one binder (B), wherein binder (B) comprises at least one polymer (F) as above defined; and
c) an electrolyte solution [solution (ES)] comprising at least one metal salt [metal salt (S)] and a liquid medium [medium (L1)].

In another aspect, the present invention provides the use of either the electrode-forming composition (C1) or the electrode-forming composition (C2) in a process for the manufacture of an electrode (E), said process comprising:
(I) providing a metal substrate having at least one surface;
(II) providing either an electrode-forming composition (C1) or an electrode-forming composition (C2) as above defined;
(III) applying either the composition (C1) or the composition (C2) provided in step (II) onto the at least one surface of the metal substrate provided in step (I), thereby providing an assembly comprising a metal substrate coated with said composition (C1) or composition (C2) onto the at least one surface;
(IV) drying the assembly provided in step (III);
(V) optionally submitting the dried assembly obtained in step (IV) to a compression step to obtain the electrode (E) of the invention.

In a further aspect, the present invention relates to an electrochemical device, such as a secondary battery or a capacitor, comprising at least one electrode (E) as defined above.

### DESCRIPTION OF EMBODIMENTS

By the term “fluorinated monomer [monomer (FM)]” it is hereby intended to denote an ethylenically unsaturated monomer comprising at least one fluorine atom, which is different from VDF.

The term “at least one fluorinated monomer” is understood to mean that the polymer (F) may comprise recurring units derived from one or more than one fluorinated monomers, in addition to VDF. In the rest of the text, the expression “fluorinated monomers” is understood, for the purposes of the present invention, both in the plural and the singular, that is to say that they denote both one or more than one fluorinated monomers as defined above.

Non limitative examples of suitable monomers (FM) include, notably, the followings:
C₂-C₈ perfluoroolefins, such as tetrafluoroethylene and hexafluoropropylene;
C₂-C₈ hydrogenated fluoroolefins, such as vinyl fluoride, 1,2-difluoroethylene and trifluoroethylene;
perfluoroalkylethylenes of formula CH₂═CH—R_{f0} wherein R_{f0} is a C₁-C₆ perfluoroalkyl;
chloro- and/or bromo- and/or iodo-C₂-C₆ fluoroolefins, such as chlorotrifluoroethylene;
(per)fluoroalkylvinylethers of formula CF₂═CFOR_{f1} wherein R_{f1} is a C₁-C₆ fluoro- or perfluoroalkyl, e.g. CF₃, C₂F₅, C₃F₇;
CF₂═CFOX₀ (per)fluoro-oxyalkylvinylethers wherein X₀ is a C₁-C₁₂ alkyl group, a C₁-C₁₂ oxyalkyl group or a C₁-C₁₂ (per)fluorooxyalkyl group having one or more ether groups, such as perfluoro-2-propoxy-propyl group;
(per)fluoroalkylvinylethers of formula CF₂═CFOCF₂OR_{f2} wherein R_{f2} is a C₁-C₆ fluoro- or perfluoroalkyl group, e.g. CF₃, C₂F₅, C₃F₇ or a C₁-C₆ (per)fluorooxyalkyl group having one or more ether groups, such as —C₂F₅—O—CF₃;
functional (per)fluoro-oxyalkylvinylethers of formula CF₂═CFOY₀ wherein Y₀ is a C₁-C₁₂ alkyl group or (per)fluoroalkyl group, a C₁-C₁₂ oxyalkyl group or a C₁-C₁₂ (per)fluorooxyalkyl group having one or more ether groups and Y₀ comprising a carboxylic or sulfonic acid group, in its acid, acid halide or salt form;
fluorodioxoles, preferably perfluorodioxoles.

Preferred monomers (FM) are selected from the group consisting of tetrafluoroethylene (TFE) and chlorotrifluoroethylene (CTFE).

By the term “recurring unit bearing at least one silane group of formula —SiYₘ [unit (CS)]” it is hereby intended to denote a functional unit which chemically bonds therein a silane functional group of formula —SiYₘ,
wherein m is an integer from 1 to 3 and each occurrence of Y is a C₁-C₁₀ hydrolyzable group, preferably a C₂-C₅ hydrolyzable group.

According to a first variant of the present invention, the unit (CS) derives from at least one ethylenically unsaturated functional monomer bearing at least a silane functional group of formula —SiYₘ, wherein m and Y are as above defined. Preferably, group Y is an alkoxy group, such as an ethoxy or a methoxy group, or a C₁-C₁₀ alkyl group bearing at least one hydroxyl group.

According to the first variant of the present invention, the polymer (F) is typically obtainable by polymerization of VDF, at least one ethylenically unsaturated functional monomer bearing at least a silane functional group of formula —SiYₘ, wherein m and Y are as above defined, optionally at least one monomer (FM), and optionally at least one monomer (FPM), either in suspension in organic medium, or in aqueous emulsion, according to the procedures known in literature.

According to a second variant of the present invention, the units (CS) derive from the chemical modification of recurring units derived from at least one monomer (FPM), by reaction of the at least one functional group [group (FX)] comprised in monomer (FPM) with a compound bearing at least a silane functional group [compound (M)].

According to this second variant of the present invention, the polymer (F) is typically obtainable by a process comprising:
(i) a step of polymerization of VDF, optionally at least one monomer (FM) and at least one monomer (FPM) comprising at least one functional group (FX) to obtain a polymer (F-H) bearing at least one functional group (FX), followed by
(ii) a step of reaction of at least a portion of the groups (FX) of polymer (F-H) with a compound (M) bearing at least a silane functional group of formula —SiYₘ as below defined.

The monomer (FPM) comprises at least one functional group [group (FX)] selected from the group consisting of: hydroxyl group, amine, carboxylic, thiol and anhydride.

Monomer (FPM) can be selected from (per)fluorinated monomers and hydrogenated monomers comprising at least one functional group [group (FX)]. Hydrogenated monomers are preferred.

Suitable hydrogenated monomers (FPM) are monomers of formula (I):

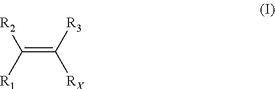

wherein:
R₁, R₂ and R₃, equal to or different from each other, are independently selected from a hydrogen atom and a C₁-C₃ hydrocarbon group, and
R_{X} is a C₁-C₂₀ hydrocarbon moiety comprising at least one functional group [group (FX)] selected from the group consisting of: hydroxyl group, amine, carboxylic acid group, thiol group and anhydride.

Rx may contain other functional groups different from group (FX) and may include heteroatoms.

The monomer (FPM) is notably selected from the group consisting of (meth)acrylic monomers of formula (II):

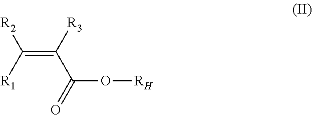

wherein R₁, R₂ and R₃, are as above defined, R_{H} is a hydrogen atom or a C₁-C₂₀ hydrocarbon moiety comprising at least one functional group [group (FX_{H})] selected from the group consisting of: hydroxyl group, amine, carboxylic group, thiol group and anhydride. More preferably, said functional group (FX_{H}) is selected from the group consisting of hydroxyl group and carboxylic group.

Non limitative examples of monomers (FPM) include, notably, hydroxyethyl(meth)acrylate, hydroxypropyl(meth)acrylate, hydroxyethylhexyl(meth)acrylate, acrylic acid (AA), and succinic acid 1-[2-(acryloyloxy)propyl] ester.

When the functional group (FX) in monomer (FPM) is an amine, it may be suitably selected from primary and secondary amines. Said amines may be both aliphatic and aromatic amines.

Compound (M), bearing at least a silane functional group, is suitably a compound of formula (III):

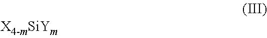

wherein m is an integer from 1 to 3, each occurrence of Y is a hydrolysable group and each occurrence of X is a hydrocarbon group, wherein at least one X comprises at least one epoxy functional group.

The unit (CS) according to this second variant derives from the chemical modification of the recurring units derived from the at least one monomer (FPM) by reaction with a compound bearing at least a compound (M), wherein at least a fraction of the group (FX) of the recurring units derived from monomer (FPM) is reacted with at least a fraction of compound (M), thereby providing recurring unit comprising at least one monomer bearing —SiYₘ pendant groups.

The polymer (F-H) typically comprises from 0.01% by moles to 10.0% by moles of recurring units derived from at least one monomer [monomer (FPM)] of formula (I):

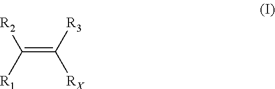

wherein:
R₁, R₂ and R₃, equal to or different from each other, are independently selected from a hydrogen atom and a C₁-C₃ hydrocarbon group, and
R_{X} is a C₁-C₂₀ hydrocarbon moiety comprising at least one functional group [group (FX)] selected from the group consisting of: hydroxyl group, amine, carboxylic group, thiol group and anhydride,
the aforementioned percentages by moles being referred to the total moles of recurring units of polymer (F-H).

Rx may contain other functional groups different from group (FX) and may include heteroatoms.

Determination of average mole percentage of monomer (FPM) recurring units in polymer (F-H) can be performed by any suitable method. Mention can be notably made of acid-base titration methods, well suited e.g. for the determination of the carboxylic groups content, of NMR methods, adequate for the quantification of monomers (FPM) comprising aliphatic hydrogen atoms in side chains, of weight balance based on total fed monomer (FPM) and unreacted residual monomer (FPM) during polymer (F-H) manufacture.

In certain preferred embodiments, monomer (FPM) is randomly distributed in polymer (F-H). In said embodiments, a fraction of at least 40% of monomer (FPM) is randomly distributed into said polymer (F-H).

The expression “randomly distributed in polymer (F-H)” is intended to denote the percent ratio between the average number of monomer (FPM) sequences (%), said sequences being comprised between two recurring units derived from monomer (FM), and the total average number of monomer (FPM) recurring units (%), according to the following formula:

$$Fraction of randomly distribute d units ( FPM ) = \frac{average number of ( FPM ) sequences ( \% )}{average total number of ( FPM ) units ( \% )} \cdot 100$$

When each of the (FPM) recurring units is isolated, that is to say comprised between two recurring units of VDF or monomer (FM), the average number of (FPM) sequences equal the average total number of (FPM) recurring units, so the fraction of randomly distributed units (FPM) is 100%: this value corresponds to a perfectly random distribution of (FPM) recurring units.

Thus, the larger is the number of isolated (FPM) units with respect to the total number of (FPM) units, the higher will be the percentage value of fraction of randomly distributed units (FPM), as above described.

The polymer (F-H) may be amorphous or semi-crystalline.

The term “amorphous” is hereby intended to denote a polymer (F-H) having a heat of fusion of less than 5 J/g, preferably of less than 3 J/g, more preferably of less than 2 J/g, as measured according to ASTM D-3418-08.

The term “semi-crystalline” is hereby intended to denote a polymer (F-H) having a heat of fusion of from 10 to 90 J/g, preferably of from 30 to 60 J/g, more preferably of from 35 to 55 J/g, as measured according to ASTM D3418-08.

The polymer (F-H) is preferably semi-crystalline.

Preferably, the intrinsic viscosity of polymer (F-H), measured in dimethylformamide at 25° C., is comprised between 0.05 l/g and 0.80 l/g, more preferably between 0.10 l/g and 0.50 l/g even more preferably between 0.2 l/g and 0.4 l/g.

The polymer (F-H) preferably comprises recurring units derived from vinylidene fluoride (VDF), at least one monomer (FPM) as defined above and, optionally, at least one further monomer (FM) different from VDF. The further monomer (FM) in polymer (F-H) is preferably HFP.

The polymer (F-H) preferably comprises:
(a) at least 60% by moles, preferably at least 75% by moles, more preferably at least 85% by moles of vinylidene fluoride (VDF);
(b) optionally, from 0.1% to 15% by moles, preferably from 0.5% to 10% by moles, more preferably from 1% to 5% by moles of at least one monomer (FM) selected from vinyl fluoride (VF1), chlorotrifluoroethylene (CTFE), hexafluoropropylene (HFP), tetrafluoroethylene (TFE), trifluoroethylene (TrFE), perfluoromethylvinylether (PMVE); and
(c) from 0.01% to 10% by moles, preferably from 0.05% to 5% by moles, more preferably from 0.1% to 2% by moles of at least one monomer (FPM) of formula (I) as defined above.

The polymer (F-H) is typically obtainable by emulsion polymerization or suspension polymerization.

The step (ii) of reaction of at least a portion of the polymer (F-H) with a compound (M) bearing at least a silane functional group comprises:
providing a composition [composition (C)] containing a liquid medium [medium (L)] and at least one polymer (F-H) as above defined, and
contacting composition (C) with at least a compound (M) as above defined to obtain a mixture (Cm) at least comprising polymer (F) and medium (L).

For the purpose of the present invention, by the term “liquid medium [medium (L)]” it is hereby intended to denote one or more substances in the liquid state at 20° C. under atmospheric pressure.

According to some embodiments of the present invention, said medium (L) is preferably selected from organic carbonates, ionic liquids (IL), solvents (S), or mixtures thereof.

Within the present invention, solvent (S) is intended to denote a solvent suitable for dissolving polymer (F-H) as defined above. To this aim, solvent (S) is typically selected from the group consisting of: N-methyl-2-pyrrolidone (NMP), N,N-dimethylformamide, N,N-dimethylacetamide, dimethylsulfoxide, hexamethylphosphamide, dioxane, tetrahydrofuran, tetramethylurea, triethyl phosphate, and trimethyl phosphate, aliphatic ketones, cycloaliphatic ketones, cycloaliphatic esters. These solvents may be used singly or in mixture of two or more species.

According to a first embodiment of the invention, said medium (L) comprises at least one organic carbonate as the only medium (L).

Non-limiting examples of suitable organic carbonates include, notably, ethylene carbonate, propylene carbonate, mixtures of ethylene carbonate and propylene carbonate, dimethyl carbonate, diethyl carbonate, ethyl-methyl carbonate, butylene carbonate, vinylene carbonate, fluoroethylene carbonate, fluoropropylene carbonate and mixtures thereof.

According to a second embodiment of the invention, said medium (L) comprises at least one ionic liquid (IL) as the only medium (L).

By the term “ionic liquid (IL)”, it is hereby intended to denote a compound formed by the combination of positively charged cations and negatively charged anions which exists in the liquid state at temperatures below 100° C. under atmospheric pressure.

The ionic liquid (IL) can be selected from protic ionic liquids (ILₚ), aprotic ionic liquids (ILₐ) and mixtures thereof.

By the term “protic ionic liquid (ILₚ)”, it is hereby intended to denote an ionic liquid wherein the cation comprises one or more H⁺ hydrogen ions.

Non-limitative examples of cations comprising one or more H⁺ hydrogen ions include, notably, imidazolium, pyridinium, pyrrolidinium or piperidinium rings, wherein the nitrogen atom carrying the positive charge is bound to a H⁺ hydrogen ion.

By the term “aprotic ionic liquid (ILₐ)”, it is hereby intended to denote an ionic liquid wherein the cation is free of H⁺ hydrogen ions.

The ionic liquid (IL) is typically selected from those comprising as cation a sulfonium ion or an imidazolium, pyridinium, pyrrolidinium or piperidinium ring, said ring being optionally substituted on the nitrogen atom, in particular by one or more alkyl groups with 1 to 8 carbon atoms, and on the carbon atoms, in particular by one or more alkyl groups with 1 to 30 carbon atoms.

According to another embodiment of the invention, said medium (L) comprises a mixture of at least one organic carbonate as defined above and at least one ionic liquid (IL) as defined above.

According to further embodiment of the invention, said medium (L) comprises a mixture of at least one organic solvent and at least one organic carbonate as defined above and/or at least one ionic liquid (IL) as defined above.

The medium (L) in composition (C) may further comprise one or more additives.

Should one or more additives be present in the liquid medium, non-limitative examples of suitable additives include, notably, those which are soluble in the liquid medium.

In step (ii), composition (C) is contacted with at least a compound (M) of formula (III):

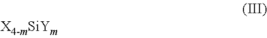

wherein m is an integer from 1 to 3, each occurrence of Y is a hydrolysable group and each occurrence of X is a hydrocarbon group, wherein at least one X comprises at least one epoxy functional group.

The weight ratio between the amount of compound (M) and polymer (F-H) that are reacted in step (ii) is advantageously from 0.01 to 0.5, preferably from 0.050 to 0.25.

The polymer (F-H) and the compound (M) are reacted at temperatures typically comprised between 20° C. and 250° C.

The skilled in the art will properly select the temperature depending on the boiling point of the medium (L), the equipment and the technique used for the reactions in the process.

Under step (ii) the composition (C) advantageously further comprises at least one catalyst.

The catalyst for the grafting reaction of polymer (F-H) with compound (M) is preferably selected from the group consisting of organic aluminium compounds such as aluminum trifluoromethanesulfonate.

In general, the molar amount of compound (M) added in step (ii) corresponds at least to the molar amount of monomer (FPM) present in the composition (C).

When the molar amount of compound (M) added in step (ii) is lower than the molar amount of monomer (FPM) present in the composition (C), polymer (F) includes recurring units derived from monomer (FPM) bearing unreacted functional groups (FX) selected from the group consisting of: hydroxyl group, amine, carboxylic group, thiol group and anhydride.

The weight ratio between the amount of medium (L) and polymer (F-H) in the composition (C) is advantageously between 0.1 and 10 preferably between 1 and 4.

Under step (ii) of the process of the invention, the catalyst is typically added to the composition (C) in an amount comprised between 0.1% and 50% by moles, preferably between 0.3% and 10% by moles, more preferably between 0.5% and 5% by moles, based on the total amount by moles of compound (M).

Under step (ii) at least a fraction of the group (FX) of monomer (FPM) of polymer (F-H) is reacted with at least a fraction of compound (M), thereby providing a composition comprising at least one polymer (F) bearing —SiYₘ pendant groups.

Polymer (F) for use in the binder (B) of the present invention is preferably obtained according to the second variant as above defined.

The process for preparing polymer (F) can be suitably carried out in a closed device, such as a reactor or in a semi-closed device, such as a twin-screw compounder or an internal mixer, wherein the reaction in step (ii) is carried out at high temperature at a temperature in the range of from 90 to 120° C.

The residence time in said devices depends on the equipment used and also on the reactivity of the system. The skilled in the art will select the proper timing for completing the reactions.

The time of the reaction shall be adapted to the device architecture and rpm. The residence time in a semi-closed is typically lower than 10 minutes, preferably lower than 5 minutes.

The process for preparing polymer (F) is suitably carried out in a semi-closed device when the medium (L) in the composition (C) is selected from organic carbonates, ionic liquids (IL).

When the process for preparing polymer (F) is carried out in a closed device, polymer (F) may be isolated as solid from the composition (Cm) resulting after step (ii): the solid can then optionally be dried and recovered.

Polymer (F) obtained as above defined can further be grinded and isolated as a powder.

When the process for preparing polymer (F) is carried out in semi-closed device, the resulting polymer (F) can be pelletized after recovery.

Polymer (F) obtained as above defined, either in closed reactor or in a semi-closed device, can then be washed with a polar solvent, which may typically be selected from ketones.

Then, the polymer (F) can be filtered, washed and then dried at a temperature typically comprised between 25° C. and 100° C.

Drying can be performed either under atmospheric pressure or under vacuum. Alternatively, drying can be performed under modified atmosphere, e.g. under an inert gas, typically exempt notably from moisture (water vapour content of less than 0.001% v/v).

Polymer (F) obtained as above defined is substantially free from residual liquid medium (L).

Alternatively, the mixture (Cm) obtained at the end of step (ii) can be used for the preparation of electrodes without any further washing and/or drying step.

In another aspect, the present invention provides an electrode-forming composition [composition (C1)] for use in the preparation of electrodes for electrochemical devices, characterized by comprising:
a) at least one electrode active material (AM);
b) at least one binder (B), wherein binder (B) comprises at least one polymer (F) as above defined; and
c) at least one organic solvent (OS).

The organic solvent (OS) may preferably be a polar one, examples of which may include: N-methyl-2-pyrrolidone, N,N-dimethylformamide, N,N-dimethylacetamide, dimethylsulfoxide, hexamethylphosphamide, dioxane, tetrahydrofuran, tetramethylurea, triethyl phosphate, and trimethyl phosphate. As the vinylidene fluoride polymer used in the present invention has a much larger polymerization degree than a conventional one, it is further preferred to use a nitrogen-containing organic solvent having a larger dissolving power, such as N-methyl-2-pyrrolidone, N,N-dimethylformamide or N,N-dimethylacetamide among the above-mentioned organic solvents. These organic solvents may be used singly or in mixture of two or more species.

In one preferred embodiment of the present invention, the electrode-forming composition (C1) is prepared by a first dissolution of the binder (B) in solvent (OS) to provide a binder solution [solution (BS)], followed by the addition of the active material (AM).

For obtaining the binder solution (BS) as above detailed, it is preferred to dissolve 0.1-10 wt. parts, particularly 1-5 wt. parts, of the copolymer (F) in 100 wt. parts of such an organic solvent (OS).

In order to prepare the binder solution (BS), it is preferred to dissolve the polymer (F) in an organic solvent (OS) at a temperature of 30-200° C., more preferably 40-60° C., further preferably 50-150° C.

For the purpose of the present invention, the term “electrode active material” is intended to denote a compound that is able to incorporate or insert into its structure, and substantially release therefrom, alkaline or alkaline-earth metal ions during the charging phase and the discharging phase of an electrochemical cell. The electrode active material is preferably able to incorporate or insert and release lithium ions or sodium ions.

The nature of the electrode active material in the electrode-forming composition (C1) depends on whether said composition is used in the manufacture of a negative electrode (anode) or a positive electrode (cathode).

The conventional active materials at the positive electrode of sodium-ion batteries are generally selected from Na-based layered transition-metal oxides, Prussian blue analogs and polyanion-type materials.

In some embodiments the active materials are Na-based layered transition-metal oxides classified as O3-, P2-, and P3-types depending on the stacking sequence of oxygen layers. P2-type structures generally respond to the general formula NaxMO₂ wherein M stands for a transition metal ion such as Co, Mn and x is ⅔.

In some embodiments the active materials are Prussian blue analogs (PBA) of general formula AₓP[R(CN)₆]_{1-y}·mH₂O, with A being and alkali metal ion, P being a N-coordinated transition metal ion, R being a C-coordinated transition metal ion, y being a [R(CN)₆] vacancy, with 0≤x≤2 and 0≤y<1, such as Na_{0.81}Fe[Fe(CN)₆]_{0.79}, NaFe₂(CN)₆, Na_{1.63}Fe_{1.89}(CN)₆, Na_{1.72}MnFe(CN)₆, Na_{1.76}Ni_{0.12}Mn_{0.88}[Fe(CN)₆]_{0.98}, Na₂NiₓCo₁₋ₓFe(CN)₆ with 0≤x≤1 e.g. Na₂CoFe(CN)₆.

In some other embodiments the active materials are polyanion-type materials of general formula NaₓM_{y}(XO₄)ₙ (where X=S, P, Si, As, Mo and W, and M is transition metal), which possess a series of tetrahedron anion units (XO₄)ⁿ⁻ and their derivatives (XₘO₃ₘ₊₁)ⁿ⁻. Among them, phosphates NaMPO₄ such as NaFePO₄, Na_{0.7}FePO₄ or NaMnPO₄; natrium (sodium) superionic conductor of NASICON-type structures of general formula NaₓM₂(XO₄)₃ (where 1≤x≤4, M=V, Fe, Ni, Mn, Ti, Cr, Zr; X=P, S, Si, Se, Mo—with single transition metal type such as Na₃V₂(PO₄)₃ (NVP), Na₃Cr₂(PO₄)₃, Na₃Fe₂(PO₄)₃; —with binary transition metal type such as Na₂VTi(PO₄)₃, Na₃FeV(PO₄)₃, Na₄MnV(PO₄)₃, Na₃MnZr(PO₄)₃, Na₃MnTi(PO₄)₃, Na₄Fe₃(PO₄)₂(P₂O₇) (NFPP); pyrophosphates Na₂FeP₂O₇, Na₂MnP₂O₇, Na₂CoP₂O₇, Na₄₋ₓFe_{2+x/2}(P₂O₇)₂ with ⅔≤x≤⅞ e.g. Na_{3.12}Fe_{2.44}(P₂O₇)₂ or Na_{3.32}Fe_{2.34}(P₂O₇)₂, Na₂(VO)P₂O₇, Na₇V₃(P₂O₇)₄; fluorophosphates NaVPO₄F, Na₂CoPO₄F, Na₂FePO₄F, Na₂MnPO₄F, Na₃(VO₁₋ₓPO₄)₂F₁₊₂ₓ (with 0≤x≤1) e.g. Na₃(VOPO₄)₂F or Na₃V₂(PO₄)₂F₃ (NVPF); fluoro sulfates such as NaMSO₄F (with M=Fe, Co, Ni); mixed phosphates/pyrophosphates of general formula Na₄M₃(PO₄)₂(P₂O₇) (with M representing transition metals) such as Na₄Mn₃(PO₄)₂(P₂O₇), Na₄Co₃(PO₄)₂(P₂O₇), Na₄Ni₃(PO₄)₂(P₂O₇), Na₄Fe₃(PO₄)₂(P₂O₇) (NFPP), Na₇V₄(P₂O₇)₄(PO₄); sulfates such as Na₂Fe₂(SO₄)₃, Na₂₊₂ₓFe₂₋ₓ(SO₄)₃, Na₂₊₂ₓCo₂₋ₓ(SO₄)₃, Na₂₊₂ₓMn₂₋ₓ(SO₄)₃ (where 0≤x≤1); silicates of general formula Na₂MSiO₄ (with M=Mn, Fe, Co and Ni).

In some preferred embodiments the active materials are fluorophosphates preferably selected from the list consisting of NaVPO₄F, Na₂CoPO₄F, Na₂FePO₄F, Na₂MnPO₄F, Na₃(VO₁₋ₓPO₄)₂F₁₊₂ₓ (with 0≤x≤1) e.g. Na₃(VOPO₄)₂F or Na₃V₂(PO₄)₂F₃ (NVPF).

The conventional active materials at the positive electrode of lithium-ion batteries may comprise a composite metal chalcogenide of formula LiMQ₂, wherein M is at least one metal selected from transition metals such as Co, Ni, Fe, Mn, Cr and V and Q is a chalcogen such as 0 or S. Among these, it is preferred to use a lithium-based composite metal oxide of formula LiMO₂, wherein M is the same as defined above. Preferred examples thereof may include LiCoO₂, LiNiO₂, LiNiₓCo₁₋ₓO₂ (0<x<1) and spinel-structured LiMn₂O₄.

As an alternative, still in the case of forming a positive electrode for a Lithium-ion secondary battery, the electrode active material (AM) may comprise a lithiated or partially lithiated transition metal oxyanion-based electro-active material of formula M₁M₂(JO₄)_{f}E_{1-f}, wherein M₁ is lithium, which may be partially substituted by another alkali metal representing less than 20% of the M₁ metals, M₂ is a transition metal at the oxidation level of +2 selected from Fe, Mn, Ni or mixtures thereof, which may be partially substituted by one or more additional metals at oxidation levels between +1 and +5 and representing less than 35% of the M₂ metals, including 0, JO₄ is any oxyanion wherein J is either P, S, V, Si, Nb, Mo or a combination thereof, E is a fluoride, hydroxide or chloride anion, f is the molar fraction of the JO₄ oxyanion, generally comprised between 0.75 and 1.

The M₁M₂(JO₄)_{f}E_{1-f} electro-active material as defined above is preferably phosphate-based and may have an ordered or modified olivine structure.

More preferably, the electrode active material (AM) in the case of forming a positive electrode has formula Li₃₋ₓM′_{y}M″_{2-y}(JO₄)₃ wherein 0≤x≤3, 0≤y≤2, M′ and M″ are the same or different metals, at least one of which being a transition metal, JO₄ is preferably PO₄ which may be partially substituted with another oxyanion, wherein J is either S, V, Si, Nb, Mo or a combination thereof. Still more preferably, the electrode active material is a phosphate-based electro-active material of formula Li(FeₓMn₁₋ₓ)PO₄ wherein 0≤x≤1, wherein x is preferably 1 (that is to say, lithium iron phosphate of formula LiFePO₄).

In the case of forming a negative electrode for a Lithium-ion secondary battery, the electrode active material (AM) may preferably comprise one or more carbon-based materials and/or one or more silicon-based materials.

In some embodiments, the carbon-based materials may be selected from graphite, such as natural or artificial graphite, graphene, or carbon black.

These materials may be used alone or as a mixture of two or more thereof.

The carbon-based material is preferably graphite.

The silicon-based compound may be one or more selected from the group consisting of chlorosilane, alkoxysilane, aminosilane, fluoroalkylsilane, silicon, silicon chloride, silicon carbide and silicon oxide.

More particularly, the silicon-based compound may be silicon oxide or silicon carbide.

When present in the electrode active material, the silicon-based compounds are comprised in an amount ranging from 1 to 60% by weight, preferably from 5 to 30% by weight with respect to the total weight of the electro active compounds.

One or more optional electroconductivity-imparting additives may be added in order to improve the conductivity of a resulting electrode made from the composition of the present invention. Conducting agents for batteries are known in the art.

Examples thereof may include: carbonaceous materials, such as carbon black, graphite fine powder, carbon nanotubes, graphene, or fiber, or fine powder or fibers of metals such as nickel or aluminum. The optional conductive agent is preferably carbon black. Carbon black is available, for example, under the brand names, Super P® or Ketjenblack®.

When present, the conductive agent is different from the carbon-based material described above.

The amount of optional conductive agent is preferably from 0 to 30 wt. % of the total solids in the electrode forming composition. In particular, for cathode forming compositions the optional conductive agent is typically from 0 wt. % to 10 wt. %, more preferably from 0 wt. % to 5 wt. % of the total amount of the solids within the composition.

For anode forming compositions which are free from silicon based electro active compounds the optional conductive agent is typically from 0 wt. % to 5 wt. %, more preferably from 0 wt. % to 2 wt. % of the total amount of the solids within the composition, while for anode forming compositions comprising silicon based electro active compounds it has been found to be beneficial to introduce a larger amount of optional conductive agent, typically from 0.5 to 30 wt. % of the total amount of the solids within the composition.

The electrode-forming composition (C1) may be obtained by adding and dispersing a powdery electrode material (an active substance for a battery or an electric double layer capacitor), and optional additives, such as an electroconductivity-imparting additive and/or a viscosity modifying agent, into the binder solution (BS) as defined above.

When the binder solution (BS) is prepared separately and subsequently combined with an electrode active material and optional conductive material and other additives to prepare composition (C1), an amount of organic solvent (OS) sufficient to create a stable suspension is employed. The amount of solvent (OS) used may range from the minimum amount needed to create a stable suspension to an amount needed to achieve a desired total solid content in an electrode mixture after the active electrode material, optional conductive material, and other solid additives have been added.

The total solid content (TSC) of the composition (C1) of the present invention is typically comprised between 15 and 70 wt. %, preferably from 40 to 60 wt. % over the total weight of the composition (C1). The total solid content of the composition (C1) is understood to be cumulative of all non-volatile ingredients thereof, notably including polymer (F), the electrode active material and any solid, non-volatile additional additive.

In a further aspect, the present invention provides an electrode-forming composition [composition (C2)] for use in the preparation of electrodes for electrochemical devices, characterized by comprising:
a) at least one electrode active material (AM);
b) at least one binder (B), wherein binder (B) comprises at least one polymer (F) as above defined; and
c) an electrolyte solution [solution (ES)] comprising at least one metal salt [metal salt (S)] and a liquid medium [medium (L1)].

In composition (C2), the electrode active material (AM) and the binder (B) are as above defined for composition (C1).

By the term “medium (L1)” it is hereby intended to denote any liquid that is electrochemically stable and that may dissolve electrolyte salts.

Medium (L1) is suitably selected from organic carbonates, ionic liquids (IL), sulfones or mixture thereof, wherein the organic carbonates, ionic liquids (IL) are as above defined.

Non-limiting examples of suitable sulfones are those of formula:

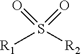

wherein R₁ and R₂ are independently any of the following: a free hydrogen, a C₁-C₂₀ alkyl group, a linear C₁-C₆ alkyl group or R₁ and R₂ taken together are a C₃-C₂₀ cycloalkyl group or a C₆-C₃₀ aryl group.

More preferably, the sulfone is sulfolane (tetramethylene sulfone).

Said metal salt (S) is typically selected from the group consisting of:
(a) MeI, Me(PF₆)ₙ, Me(BF₄)ₙ, Me(ClO₄)ₙ, Me(bis(oxalato)borate)ₙ (“Me(BOB)ₙ”), MeCF₃SO₃, Me[N(CF₃SO₂)₂]ₙ, Me[N(C₂F₅SO₂)₂]ₙ, Me[N(CF₃SO₂)(RFSO₂)]ₙ, wherein RF is C₂F₅, C₄F₅ or CF₃OCF₂CF₂, Me(AsF₆)ₙ, Me[C(CF₃SO₂)₃]ₙ, Me₂Sₙ,
wherein Me is a metal, preferably a transition metal, an alkaline metal or an alkaline-earth metal, more preferably Me being Li, Na, K, Mg, Al or Cs, even more preferably Me being Li, and n is the valence of said metal, typically n being 1 or 2,
(b)
wherein R′F is selected from the group consisting of F, CF₃, CHF₂, CH₂F, C₂HF₄, C₂H₂F₃, C₂H₃F₂, C₂F₅, C₃F₇, C₃H₂F₅, C₃H₄F₃, C₄F₉, C₄H₂F₇, C₄H₄F₅, C₅F₁₁, C₃F₅OCF₃, C₂F₄OCF₃, C₂H₂F₂OCF₃ and CF₂OCF₃, and
(c) combinations thereof.

Said metal salt (S) is advantageously dissolved by said medium (L1).

On this regard, the concentration of said metal salt (S) in the medium (L1) is advantageously at least 0.01 M, preferably at least 0.025 M, more preferably at least 0.05 M.

The concentration of the metal salt (S) in the medium (L1) is advantageously at most 5 M, preferably at most 3 M, more preferably at most 2 M, even more preferably at most 1 M.

In one preferred embodiment of the present invention, the electrode-forming composition (C1) and the composition (C2) include at least one acid.

The acid is preferably an organic acid, more preferably selected from formic acid or citric acid.

The Applicant has surprisingly found that when an amount of at least one organic salt acid is present in the electrode-forming compositions of the present invention, the adhesion of said composition to metal substrates is improved.

In another object, the present invention pertains to the use of either the electrode-forming composition (C1) or the composition (C2) in a process for the manufacture of an electrode (E), said process comprising:
(I) providing a metal substrate having at least one surface;
(II) providing either an electrode-forming composition (C1) or a composition (C2) as above defined;
(III) applying the composition (C1) or composition (C2) provided in step (II) onto the at least one surface of the metal substrate provided in step (I), thereby providing an assembly comprising a metal substrate coated with said composition (C1) or composition (C2) onto the at least one surface;
(IV) drying the assembly provided in step (III);
(V) optionally submitting the dried assembly obtained in step (IV) to a compression step to obtain the electrode (E) of the invention.

Drying step (IV) may serve to also remove optional remained liquid medium (L) which may be kept entrapped into the polymer (F) as formed, which results in electrodes endowed with further improved adhesion to current collector.

In a further object, the present invention pertains to the electrode (E) obtainable by the process of the invention.

In a further aspect, the present invention provides a process for manufacturing an electrode [electrode (E1)] for electrochemical cell, said process comprising:
A) providing a partially fluorinated fluoropolymer [polymer (F)] as above defined;
B) dry mixing at least one electrode active material (AM), the polymer (F) as above defined, and optionally, at least one conductive agent in the absence of solvent to provide a dry electrode forming composition [composition (C3)];
C) feeding the composition (C3) obtained in step B) to a compactor to form a self-supporting dry film; and
D) applying the dry film to an electrically conductive substrate to form the electrode.

The Applicant has surprisingly found that the electrode (E) and electrode (E1) of the present invention show outstanding adhesion of the binder to current collector.

The electrode (E) and electrode (E1) of the invention are thus particularly suitable for use in electrochemical devices, in particular in secondary batteries.

For the purpose of the present invention, the term “secondary battery” is intended to denote a rechargeable battery.

The secondary battery of the invention is preferably an alkaline or an alkaline-earth metal secondary battery.

The secondary battery of the invention is more preferably a Lithium-ion secondary battery.

In still a further object, the present invention pertains to an electrochemical device comprising at least one electrode (E) or an electrode (E1) of the present invention.

The electrochemical device according to the present invention, being preferably a secondary battery, comprises:
a positive electrode and a negative electrode,
   wherein at least one of the positive electrode and the negative electrode is the electrode (E) or an electrode (E1) of the present invention.

In one preferred embodiment of the present invention it is provided an electrochemical device is a secondary battery comprising:
a positive electrode and a negative electrode,
   wherein the negative electrode is the electrode (E) or the electrode (E1) according to the present invention.

An electrochemical device according to the present invention can be prepared by standard methods known to a person skilled in the art.

Should the disclosure of any patents, patent applications, and publications which are incorporated herein by reference conflict with the description of the present application to the extent that it may render a term unclear, the present description shall take precedence.

The invention will be now described in more detail with reference to the following examples whose purpose is merely illustrative and not limitative of the scope of the invention.

### EXPERIMENTAL SECTION

### Raw Materials

Polymer (F-H1): VDF-AA (0.9% by moles)-HFP (2.4% by moles) polymer having a viscosity of 0.30 l/g in DMF at 25° C.
Epoxy silane (EPP-1): [3-(2,3-epoxypropoxy)propyl]triethoxysilane.
Catalyst (ATS): Aluminum trifluoromethanesulfonate.
Medium (EL-1): ethylene carbonate (EC)/propylene carbonate (PC) (1/1 by weight).

### Determination of Intrinsic Viscosity of Polymer (F)

Intrinsic viscosity (η) [dl/g] was measured using the following equation on the basis of dropping time, at 25° C., of a solution obtained by dissolving the polymer (F) in N,N-dimethylformamide at a concentration of about 0.2 g/dl using a Ubbelhode viscosimeter:

$$[ η ] = \frac{{η}_{s p} + Γ \cdot ln {η}_{r}}{( 1 + Γ ) \cdot c}$$

where c is polymer concentration [g/dl], nr is the relative viscosity, i.e. the ratio between the dropping time of sample solution and the dropping time of solvent, ηₛₚ is the specific viscosity, i.e. ηᵣ−1, and F is an experimental factor, which corresponds to 3 for polymer (F).

### General Procedure for Preparing a Polymer (F) in Semi-Closed Device:

A 15 ml twin-screw compounder (DSM Xplore) (Miniextruder) was used. All tests were run at 100 rpm. In all tests the residence time was 4 min.

### Example 1—Manufacture of F-1 with F-H1 by Processing in the Molten State

The following ingredients were put into the miniextruder at 110° C.: EL-1 (13.79 g), ATS (7.9 mg), EPP-1 (0.79 g), Polymer (F-H1) (3.94 g). The resulting product was pelletized with VariCut pelletizer (Thermo Fisher Scientific).

### Example 2—Manufacture of F-2 with F-H1 by Processing in the Molten State

The following ingredients were put into the miniextruder at 110° C.: EL-1 (10.64 g), ATS (14.2 mg), EPP-1 (1.42 g), Polymer (F-H1) (7.09 g). The resulting product was pelletized with VariCut pelletizer (Thermo Fisher Scientific).

### Example 3—Preparation of the Electrodes with NMC 622 Active Material

Positive electrodes having final composition of 96.5% by weight of NMC 622 (Umicore, d50 11.6 μm), 1.5% by weight of either polymer (F-H1), polymers (F-1) or polymer (F-2) and 2% by weight of conductive additive were prepared as follows.

### Example 3a) Reference Composition with Polymer (F-H1)

A dispersion was prepared by mixing for 10 minutes in a centrifugal mixer 24.98 g of a 8% by weight of a solution of the polymer (F-H1) in NMP, 128.5 g of NMC622, 2.7 g of SC-65 and 23.8 g of NMP to give composition 3a).

### Example 3b) Formulation with Polymer (F-1)

A dispersion was prepared by mixing for 10 minutes in a centrifugal mixer 9.51 g of polymer (F-1) (about 2 g of pure polymer), pre-dissolved in 39.3 g of NMP, 128.5 g of NMC622 and 2.7 g of SC-65 to give composition 3b).

### Example 3c) Formulation with Polymer (F-2)

A dispersion was prepared by mixing for 10 minutes in a centrifugal mixer 5.40 g of polymer (F-2) (about 2 g of pure polymer), pre-dissolved in 43.4 g of NMP, 128.5 g of NMC622 and 2.7 g of SC-65 to give composition 3c).

For each composition 3a), 3b) or 3c), a final slurry was obtained by further stirring with high speed disk impeller at 2000 rpm for 70 minutes.

Positive electrodes a), b) or c) were obtained by casting the obtained compositions on 15.5 μm thick Aluminium foil with doctor blade and drying the coated layers in a vacuum oven at temperature of 90° C. for about 50 minutes. The thickness of the dried coating layers was about 145 μm, with a loading of 30 mg/cm² (+/−2). The electrode b), obtained by composition 3b) retained some residual EL-1.

### Example 4: Adhesion

Adhesion Peeling Force between Aluminium foil and Electrode was measured as follows:
180° peeling tests were performed following the setup described in the standard ASTM D903 at a speed of 300 mm/min at 20° C. in order to evaluate the adhesion of the dried coating layer as above defined to the Aluminium foil.

The values of adhesion are shown in Table 1.

TABLE 1

| | | | | EL- |
|---|---|---|---|---|
| | | IV | Adhesion | 1/polymer |
| Electrode | Polymer | [l/g] | [N/m] | F-H1 |
| a) | F-H1 | 0.30 | 129 | - |
| b) | F-1 | - | 109.1 | 3.5 |
| c) | F-2 | - | 146.5 | 1.5 |

The results demonstrate that the polymers of the present invention show a suitable adhesion to current collector, similar or superior to that of polymer (F-H1) alone. In particular, the adhesion to metals is further improved when complete removal of the liquid medium used in the preparation of the polymer is done.

1. A binder composition [binder (B)] for use in the preparation of electrodes for electrochemical devices, characterized by comprising at least one VDF-based polymer [polymer (F)], said polymer (F) comprising in the backbone:
recurring units bearing at least one silane group [unit (CS)] of formula —SiYₘ,
wherein m is an integer from 1 to 3 and each occurrence of Y is a C₁-C₁₀ hydrolyzable group;
optionally, recurring units derived from at least one fluorinated monomer [monomer (FM)] different from VDF; and
optionally, recurring units derived from at least one monomer (FPM) comprising at least one functional group [group (FX)] selected from the group consisting of: hydroxyl group, amine, carboxylic acid group, thiol group and anhydride.

2. The binder (B) according to claim 1, wherein monomer (FM) is selected from the group consisting of tetrafluoroethylene (TFE) and chlorotrifluoroethylene (CTFE).

3. The binder (B) according to claim 1, wherein the unit (CS) derives from at least one ethylenically unsaturated functional monomer bearing at least a silane functional group of formula —SiYₘ, wherein m is an integer from 1 to 3 and each occurrence of Y is a C₁-C₁₀ hydrolyzable group.

4. The binder (B) according to claim 1, wherein the unit (CS) derives from the chemical modification of the recurring units derived from at least one monomer (FPM) comprising at least one functional group [group (FX)] selected from the group consisting of: hydroxyl group, amine, carboxylic acid group, thiol group and anhydride wherein at least a fraction of the group (FX) of the recurring units derived from monomer (FPM) is reacted with at least a fraction of compound (M), of formula (III): 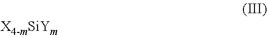
wherein m is an integer from 1 to 3, each occurrence of Y is a hydrolysable group and each occurrence of X is a hydrocarbon group, wherein at least one X comprises at least one epoxy functional group, thereby providing recurring unit comprising at least one monomer bearing —SiYₘ pendant groups.

5. The binder (B) according to claim 4, wherein monomer (FPM) is a hydrogenated monomer (FPM) of formula (I): 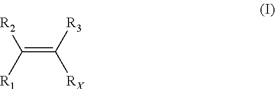
wherein:
R₁, R₂ and R₃, equal to or different from each other, are independently selected from a hydrogen atom and a C₁-C₃ hydrocarbon group, and
R_{X} is a C₁-C₂₀ hydrocarbon moiety comprising at least one functional group [group (FX)] selected from the group consisting of hydroxyl group, amine, carboxylic acid group, thiol group and anhydride.

6. The binder (B) according to claim 5, wherein the hydrogenated monomer (FPM) is selected from the group consisting of (meth)acrylic monomers of formula (II): 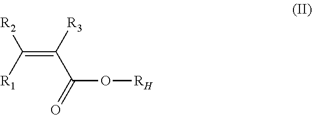
wherein R₁, R₂ and R₃, are as above defined, RH is a hydrogen atom or a C₁-C₂₀ hydrocarbon moiety comprising at least one functional group [group (FX_{H})] selected from the group consisting of: hydroxyl group, amine, carboxylic group, thiol group and anhydride.

7. The binder (B) according to claim 4, wherein monomer (FPM) is selected from the group consisting of hydroxyethyl(meth)acrylate, hydroxypropyl(meth)acrylate, hydroxyethylhexyl(meth)acrylate, acrylic acid (AA) and succinic acid 1-[2-(acryloyloxy)propyl] ester.

8. A process for preparing a polymer (F) according to claim 4, said process comprising:
(i) a step of polymerization of VDF, optionally at least one monomer (FM) and at least one monomer (FPM) comprising at least one functional group (FX) to obtain a polymer (F-H), followed by
(ii) a step of reaction of at least a portion of the groups (FX) of monomer (FPM) of polymer (F-H) with a compound (M) of formula (III): 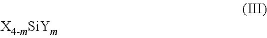
wherein m is an integer from 1 to 3, each occurrence of Y is a hydrolysable group and each occurrence of X is a hydrocarbon group, wherein at least one X comprises at least one epoxy functional group.

9. The process according to claim 8, wherein step (ii) comprises:
providing a composition [composition (C)] containing a liquid medium [medium (L)] and at least one polymer (F-H) as above defined, and
contacting composition (C) with at least a compound (M) to obtain a mixture (Cm).

10. The process according to claim 8, wherein medium (L) is selected from organic carbonates, ionic liquids (IL), solvents (S), or mixtures thereof.

11. An electrode-forming composition [composition (C1)] for use in the preparation of electrodes for electrochemical devices, characterized by comprising:
a) at least one electrode active material (AM);
b) at least one binder (B), according to claim 1; and
c) at least one organic solvent (OS).

12. A process for the manufacture of an electrode (E), said process comprising:
(I) providing a metal substrate having at least one surface;
(II) providing an electrode-forming composition (C1) according to claim 1;
(III) applying the composition (C1) provided in step (II) onto the at least one surface of the metal substrate provided in step (I), thereby providing an assembly comprising a metal substrate coated with said composition (C1) onto the at least one surface;
(IV) drying the assembly provided in step (III);
(V) optionally submitting the dried assembly obtained in step (IV) to a compression step to obtain the electrode (E) of the invention.

13. An electrochemical device, comprising at least one electrode (E) obtained by the process according to claim 12.

14. An electrochemical device comprising the polymer electrolyte membrane according to claim 13.

15. The electrochemical device of claim 13, wherein the electrochemical device is a secondary battery or a capacitor.
